(19) United States
(12) Patent Application Publication
(10) Pub. No.: US 2014/0122957 A1
(43) Pub. Date: May 1, 2014

(54) Method, an Apparatus and a Network Element for Dynamical TDD Configuration

(71) Applicant: Broadcom Corporation, Irvine, CA (US)

(72) Inventors: Gilles Charbit, Farnborough (GB); Jing Han, Beijing (CN); Chunyan Gao, Beijing (CN); Haiming Wang, Beijing (CN)

(21) Appl. No.: 14/122,284

(22) PCT Filed: May 30, 2011
(86) PCT No.: PCT/CN2011/074887

§ 371 Date: Nov. 26, 2013

(51) Int. Cl. H04L 1/08

(52) U.S. Cl. CPC H04L 1/08
USPC 714/748

(57) ABSTRACT

A method, an apparatus for wireless communication and a network element for handling the retransmission of a failed packet during the TDD configuration change. The method comprises receiving at least one failed packet in a first TDD configuration; receiving information to change from the first TDD configuration to a second TDD configuration; sending a repeat request for said at least one failed packet; and receiving a retransmission of the failed packets of the first TDD configuration in the second TDD configuration.

### FIELD OF THE INVENTION

The invention relates to mobile communication networks. More specifically, the invention relates to the radio interface between an apparatus for wireless communication and a network element, comprising dynamic uplink/downlink configuration for time division duplex.

### BACKGROUND OF THE INVENTION

Long Term Evolution (LTE) was introduced in release 8 of the 3^{rd} Generation Partnership Project (3GPP) which is a specification for 3^{rd} generation mobile communication systems. LTE is a technique for mobile data transmission that aims to increase data transmission rates and decrease delays, among other things. 3GPP release 10 introduced a next version, LTE Advanced, fulfilling 4^{th} generation system requirements.

Both LTE and LTE Advanced may utilize a technique called time division duplex (TDD) for separating the transmission directions from the user to the base station and back. In TDD mode, the downlink and the uplink are on the same frequency and the separation occurs in the time domain, so that each direction in a connection is assigned to specific timeslots.

Herein, the term “downlink” (DL) is used to refer to the link from the base station to the mobile device or user equipment, and the term “uplink” (UL) is used to refer to the link from the mobile device or user equipment to the base station.

One benefit of LTE TDD system is an asymmetric uplink-downlink allocation. This is obtained by providing seven different semi-statically configured uplink-downlink configurations. These allocations can provide from 40% to 90% of the DL subframes. The mechanism according to prior art for adapting UL/DL allocation is based on a system information change procedure. This approach may cause problems in a traffic situation, where the TDD configuration is changed while the receiver demands retransmitting of failed packets. According to current proposals the system information is sent at the interval of at least 640 ms. The dynamical TDD configuration cannot adapt to various instantaneous traffic situations. This leads to inefficient resource utilization, especially in cells with a small number of users, where the traffic situation changes more frequently.

### PURPOSE OF THE INVENTION

The purpose of the invention is to propose a new method, an apparatus for wireless communication and a network element for handling the retransmission of a failed packet during the TDD configuration change.

### SUMMARY

The invention discloses a method comprising receiving at least one failed packet in a first TDD configuration; receiving information to change from the first TDD configuration to a second TDD configuration; sending a repeat request for said at least one failed packet; and receiving a retransmission of the failed packets of the first TDD configuration in the second TDD configuration. The TDD configuration change indicates the dynamic change between the balance of uplink and downlink and characteristics to meet the load conditions. The first and second TDD configuration may be any of the defined configurations that are available between the network element and the apparatus for wireless communication. The network may indicate the TDD configuration change to the apparatus for wireless communication by any means known in prior art.

In one embodiment the method comprises flushing a HARQ buffer after receiving information to change from the first TDD configuration to the second TDD configuration and receiving the retransmission of the failed packets of the first TDD configuration in the second TDD configuration as new packets. Flushing a buffer refers to emptying the temporary data storage, which may be a file in a file structure, a separate memory chip or a functionality configured to operate in a portion of an integrated circuit. Hybrid automatic repeat request, HARQ, is a combination of forward error-correcting coding and error detection using the ARQ error-control method. HARQ is used both uplink and downlink in high speed data transmission technologies such as HSDPA, HSUPA and HSPA, UMTS, the IEEE 802.16-2005 standard for mobile broadband wireless access, also known as “mobile WiMAX” and 3GPP Long Term Evolution, LTE.

In one embodiment the method comprises using a specified number of HARQ processors and downlink association set index in the second TDD configuration, wherein the downlink is configured for asynchronous HARQ. In one embodiment the method comprises using a specified number of HARQ processors and implicit timing between PUSCH (Physical Uplink Shared Channel) and PHICH/PDCCH (Physical Hybrid ARQ Indicator Channel/Physical Downlink Control Channel) in the second TDD configuration, wherein the uplink is configured for synchronous HARQ.

In one embodiment the method comprises a network element indicating to an apparatus for wireless communication a downlink process index, setting a NDI value (NDI, New Data Indicator) to indicate the retransmission, wherein the downlink is configured for asynchronous HARQ and combining received packets with packets in the corresponding HARQ process buffer used in the first TDD configuration. In one embodiment received packets are combined with packets in the corresponding HARQ process buffer used in the first TDD configuration.

In one embodiment the method comprises mapping a first uplink subframe in the second TDD configuration after a downlink feedback timing and adding a predetermined time period to the feedback timing, wherein the uplink is configured for synchronous HARQ. In one embodiment the method comprises retransmitting only normal subframes, if uplink HARQ processes in the first TDD configuration are mapped to the same uplink subframe. In one embodiment the method comprises retransmitting packets in one boundary subframe for the corresponding packets in multiple boundary subframes in the first TDD configuration.

The invention discloses also an apparatus for wireless communication, wherein after receiving at least one failed packet in a first TDD configuration and information to change from the first TDD configuration to a second TDD configuration, the apparatus is configured to; send a repeat request for said at least one failed packet; and receive a retransmission of the failed packets of the first TDD configuration in the second TDD configuration. In one embodiment the apparatus for wireless communication is configured to operate as part of a user equipment. Examples of a user equipment are a mobile phone, a mobile computing device such as a PDA, a laptop computer, an USB stick—basically any mobile device with wireless connectivity to a communication network.

In one embodiment the apparatus is configured to flush a HARQ buffer after receiving information to change from the first TDD configuration to the second TDD configuration and to receive the retransmission of the failed packets of the first TDD configuration in the second TDD configuration as new packets. In one embodiment the apparatus is configured to use a specified number of HARQ processors and downlink association set index in the second TDD configuration, wherein the downlink is configured for asynchronous HARQ. In one embodiment the apparatus is configured to use a specified number of HARQ processors and implicit timing between PUSCH and PHICH/PDCCH in the second TDD configuration, wherein the uplink is configured for synchronous HARQ. In one embodiment the apparatus is configured to detect packets to be retransmitted from the downlink process index comprising packets from the first TDD configuration and a NDI value, and combine received packets with packets in the corresponding HARQ process buffer used in the first TDD configuration, wherein the downlink is configured for asynchronous HARQ.

In one embodiment the apparatus is configured to map a first uplink subframe in the second TDD configuration after a downlink feedback timing, to add a predetermined time period to the feedback timing and to combine received packets with packets in the corresponding HARQ process buffer used in the first TDD configuration, wherein the uplink is configured for synchronous HARQ. In one embodiment the apparatus is configured to retransmit only normal subframes, if uplink HARQ processes in the first TDD configuration are mapped to the same uplink subframe. In one embodiment the apparatus is configured to retransmit packets in one boundary subframe for corresponding packets in multiple boundary subframes in the first TDD configuration.

The invention discloses also a network element for wireless communication, wherein after receiving at least one failed packet in a first TDD configuration and information to change from the first TDD configuration to a second TDD configuration, the network element is configured to send a repeat request for said at least one failed packet; and receive a retransmission of the failed packets of the first TDD configuration in the second TDD configuration. In one embodiment the network element is configured to flush a HARQ buffer after receiving information to change from the first TDD configuration to the second TDD configuration and to receive the retransmission of the failed packets of the first TDD configuration in the second TDD configuration as new packets. In one embodiment the network element is configured to use a specified number of HARQ processors and downlink association set index in the TDD configuration from uplink to downlink, wherein the downlink is configured for asynchronous HARQ. In one embodiment the network element is configured to use a specified number of HARQ processors and implicit timing between PUSCH and PHICH/PDCCH in the second TDD configuration, wherein the uplink is configured for synchronous HARQ.

In one embodiment the network element is configured to indicate to the apparatus a downlink process index, set a NDI value to indicate the retransmission and combine received packets with packets in the corresponding HARQ process buffer used in the first TDD configuration, wherein the downlink is configured for asynchronous HARQ. In one embodiment the network element is configured to combine received packets with packets in the corresponding HARQ process buffer used in the first TDD configuration. In one embodiment the network element is configured to receive only transmitted normal subframes, if uplink HARQ processes in the first TDD configuration are mapped to the same uplink subframe or to receive retransmitted packets in one boundary subframe for corresponding packets in multiple boundary subframes in the first TDD configuration.

An example of a network element according to the present invention is an evolved Node B, eNB. The evolved Node B is a base station according to 3GPP LTE. 3GPP, 3rd Generation Partnership Project, develops specifications for third generation mobile phone systems, and also from Release 8 (Rel-8) the next generation specifications often referred to as LTE, Long Term Evolution.

The invention allows the use of a simple HARQ timing procedure during dynamical TDD configuration switching at eNB and a user equipment, especially when the HARQ buffer is flushed. A further benefit of the invention is HARQ optimization during dynamical TDD configuration switching at eNB and a UE, while maintaining the HARQ timing procedure relatively simple.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an example embodiment comprising elements of the invention,

FIG. 2 is a diagram illustrating an example of TDD configuration change according to the invention, and

FIG. 3 is another diagram illustrating an example of TDD configuration change according to the invention.

### DETAILED DESCRIPTION OF THE INVENTION

Reference will now be made in detail to the embodiments of the present invention, examples of which are illustrated in the accompanying drawings.

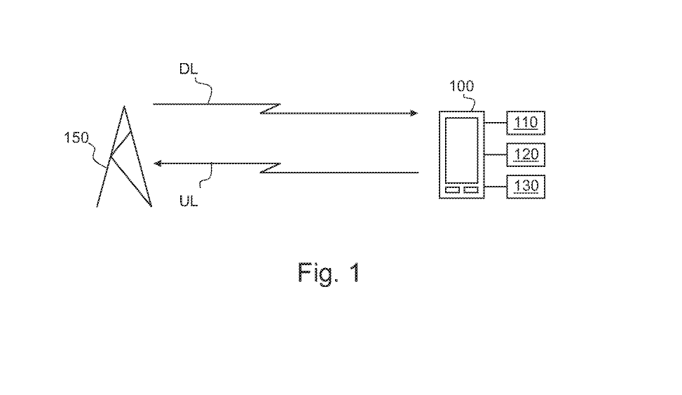

FIG. 1 is a block diagram illustrating an apparatus for wireless communication 100 according to an embodiment connected to a mobile communication network. The apparatus 100 comprises at least one controller 110, such as a processor, a memory 120 and a communication interface 130. In one embodiment the apparatus is a computer chip. Stored in the memory 120 are computer instructions which are adapted to be executed on the processor 110. The communication interface 130 is adapted to receive and send information to and from the processor 110. The apparatus 100 is commonly referred to as a user equipment UE or it may comprise a part of a user equipment.

The base station 150 is adapted to be part of a cellular radio access network such as E-UTRAN applying WCDMA technology or similar networks suitable for high speed data transmission. Such networks are often also referred to as 4G or LTE. In this example the cellular radio access network supports carrier aggregation comprising LTE and HSPA. The base station 150 illustrated in FIG. 1 symbolizes all relevant network elements required to carry out the functionality of the wireless network. One example of the base station 150 is the evolved Node B, eNB. The downlink direction DL is defined as from the network 150 to the user equipment 100, and the uplink direction UL is defined as from the user equipment 100 to the network 150.

According to prior art, dynamical TDD configuration does not fully conform to current proposals on HARQ timing, due to several HARQ parameters being TDD UL-DL configuration specific according to 3GPP TS 36.213:
HARQ processors in DL and UL subframes to allow L re-transmissions of N packets based on the channel conditions, wherein N and L are integers;
DL association set index used for Ack/Nack TTI bundling (DL asynchronous HARQ)
Implicit timing between PUSCH & PHICH/PDCCH (UL adaptive synchronous HARQ)

Another problem according to prior art is that in the lack of scheduling grant for the user equipment, it does not know the link direction of flexible subframes. As a result these subframes cannot be used for RRM measurement (RRM, Radio Resource Management), CQI measurement (CQI, Channel Quality Indicator), or filtering for channel estimation. For example the CQI in flexible subframes may differ from a fixed subframe, due to a different interference level. Enabling the CQI measurement for the user equipment in flexible subframes provides to the network relevant information for better resource scheduling. Moreover, the user equipment has to monitor all flexible subframes for PDCCH to detect whether they are uplink or downlink, thus increasing user equipment power consumption.

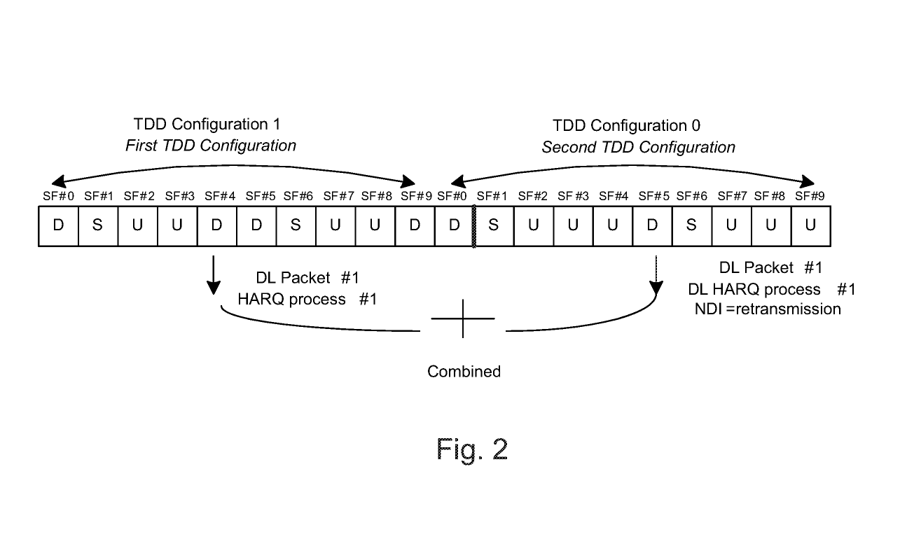

Referring to FIG. 2, in one exemplary embodiment of the invention the HARQ buffer is flushed and failed packets from the first TDD configuration are transmitted as new packets in the second TDD configuration. This example can be divided into two use cases; to downlink applying asynchronous HARQ and to uplink applying synchronous HARQ.

The case of asynchronous HARQ on downlink: A network element such as eNB uses M processors out of a total of N processors available in the first TDD configuration (M≦N). Further, DL packets #1, #2 . . . #K, are in Lk re-transmissions where 1≦Lk≦Lmax and Lmax is the maximum number of packet re-transmissions, wherein L, M and N are integers.

The eNB indicates the second TDD configuration to the user equipment UE, which subsequently flushes its HARQ processors (HARQ buffers). The eNB transmits DL packets #1, #2, . . . , #K not yet successfully received in the first TDD configuration as new first transmission in the second TDD configuration using a specified number of HARQ processors and DL association set index in the second TDD UL-DL configuration. This example avoids combining of DL first transmissions/L re-transmissions in the first TDD configuration with packet retransmissions in the second TDD configuration at the user equipment UE.

The case of synchronous HARQ on uplink: the user equipment UE uses M processors out of a total of N processors available in the first TDD configuration (M≦N). UL packets #1, #2 . . . #K, are in Lk re-transmissions where 1≦Lk≦Lmax and Lmax is the maximum number of packet re-transmissions wherein L, M and N are integers.

The eNB indicates the second TDD configuration to the user equipment UE and subsequently flushes its HARQ processors (HARQ buffers). The UE transmits UL packets #1, #2, . . . , #K not yet successfully received in the first TDD configuration as new first transmission in the second TDD configuration using a specified number of HARQ processors and implicit timing between PUSCH & PHICH/PDCCH in the second TDD UL-DL configuration. This example avoids combining of UL first transmissions/L re-transmissions in the first TDD configuration with packet retransmissions in the second TDD configuration at the eNB.

Another exemplary embodiment of the invention introduces a HARQ design that allows combining failed packets in the first TDD configuration with packet re-transmissions in the second TDD configuration. Also this example can be divided into two use cases; to downlink applying asynchronous HARQ and to uplink applying synchronous HARQ.

the case of asynchronous HARQ on downlink: The eNB uses M processors out of a total of N processors available in the first TDD configuration (M≦N). Further, DL packets #1, #2 . . . #K, are in Lk re-transmissions where 1≦Lk≦Lmax and Lmax is the maximum number of packet re-transmissions. The eNB indicates the second TDD configuration to the UE by ways according to prior art.

In the second TDD configuration, the eNB indicates to the user equipment UE the DL process index which contains DL packets #1, #2 . . . or #K not yet successfully received in the first TDD configuration, and sets the NDI value to indicate the retransmission of current DL process. The user equipment UE regards this as a retransmission of the corresponding DL processes, and combines received packets with packets in the corresponding HARQ process buffer that were used in the first TDD configuration.

The case of synchronous HARQ on uplink: The user equipment UE uses M processors out of a total of N processors available in the first TDD configuration (M≦N). UL packets #1, #2 . . . #K, are in Lk re-transmissions where 1≦Lk≦Lmax and Lmax is the maximum number of packet re-transmissions. Then eNB indicates the second TDD configuration to the user equipment UE. The retransmission of the UL process in the first TDD configuration which contains UL packets #1, #2, . . . #K not yet successfully transmitted will be mapped to the first UL subframe in the second TDD configuration after DL feedback timing plus 3 ms. The DL feedback timing for normal subframe in the first TDD configuration can be obtained by Rel-10 timing. If multiple UL HARQ processes in the first TDD configuration are mapped to the same UL subframe and if retransmission for normal subframes in the first TDD configuration happens, retransmission is applied only for normal subframes and all other retransmissions are dropped.

If retransmissions for multiple boundary subframes in the first TDD configuration occurs, only one boundary subframe is picked for retransmission and all other retransmissions are dropped. This boundary subframe could be picked by pre-defined rules, e.g. according to the DL feedback delay. The eNB sets a NDI value to indicate the retransmission on the corresponding UL subframe in the second TDD configuration.

The user equipment UE retransmits the corresponding UL processes that are selected by above rules in the mapped UL subframe in the second TDD configuration; the eNB combines received packets with packets in the corresponding HARQ process buffer that was used in the first TDD configuration.

The frame structure defined in Release 10 is kept also in a flexible TDD system, and the flexibly adjusted DL/UL configuration is selected from the seven TDD configurations defined in LTE TDD release 10. Legacy user equipments may not be scheduled any DL grants or UL grants in the flexible subframes.

From the seven TDD configurations in release 10, subframe 0,5 is always fixed to be DL, subframe 1 is always fixed to be a special subframe for providing a guard period, subframe 6 is also a special subframe or a DL subframe, while subframe 2 is always for UL. No matter which TDD configuration is applied, there are always subframes with a fixed link direction for protecting important control channels, e.g, BCH, SCH. These subframes are called fixed subframes, while the other subframes are called flexible subframes. The fixed subframes are needed for the legacy terminals as well as for new terminals.

The definition of a fixed subframe and a flexible subframe should be decided taking into account the achievable DL/UL ratio flexibility, the impact to the legacy UEs, the impact to specification and performance of important control channels. In LTE TDD system, many operations at both eNB and UE sides depend on the semi-static TDD configuration, comprising: RRM measurement, CQI measurement, Channel estimation, PDCCH detection and HARQ timing.

The user equipment UE reads from the system information the TDD configuration in the current cell, receiving the indication of the subframe to monitor the measurement, CQI measure and report, time domain filtering to get channel estimation, PDCCH detection, or DL/UL ACK/NACK feedback.

In a preferred embodiment of the invention, specified TDD configurations are used. Further, all operations based on semi-static TDD configurations are kept unchanged by a higher frequency of change of the dynamical TDD configuration.

In rel-8 specification, the TDD configuration may be changed via system information update via SIB-1. The BCCH notification period is equal to modificationPeriodCoeff*defaultPagingCycle in radio frames, where modificationPeriodCoeff is 1, 2, . . . , 8 and defaultPagingCycle is 32, 64, 128, 256. Hence, the minimum notification period can be 1×32=32 radio frames or about 0.32 seconds. The maximum notification period can be 8×256=32 radio frames or about 20.48 s.

Assumption for frequency of change for TDD configuration of HeNBs could be faster than 0.32 s, but is unlikely for macro eNBs, which are typically not changed often.

The HARQ performance is mainly affected by two types of losses:

A combining loss due to the first transmissions/L re-transmissions of packets in the first TDD configuration not combined with packet retransmissions in the second TDD configuration at the UE/eNB receiver; and
An efficiency loss due to packets (re)-transmitted by the UE/eNB in the first TDD configuration being discarded.

Because the packets transmitted/received by the UEs within a cell are typically expected to go through at first transmission with a relatively high probability (i.e. around 80%) and because the HARQ buffer flushing only occurs during the TDD configuration change (with LTE TDD system having the same TDD configuration for up to 32 radio frames or 0.32 s assuming frequency of change faster than the minimum BCCH notification period), the impact on HARQ performance at the UE or eNB is not significant.

FIG. 2 discloses an exemplary embodiment of the DL HARQ combination. In this case asynchronous HARQ is applied to downlink. In the example, DL/UL configuration is changed from TDD configuration 1 to TDD configuration 0. A DL transmission in DL HARQ process #1 in SF#4 in the first TDD configuration needs to be retransmitted. In SF#5 in the second TDD configuration, if eNB indicated DL HARQ process index is #1 and the NDI value is for retransmission, the UE will regard this as the retransmission of DL transmission in SF#4 in the first TDD configuration, and combines received packet in SF#5 in the second TDD configuration with received packet in SF#4 in the first TDD configuration.

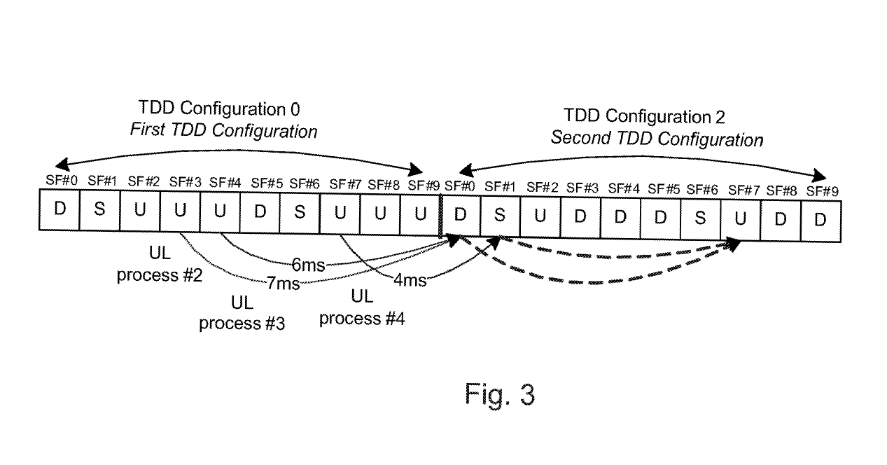

FIG. 3 discloses an example of UL HARQ combination. In the example synchronous HARQ is applied to uplink. In the example, DL/UL configuration is changed from TDD configuration 0 to TDD configuration 2. There are UL transmissions in SF#3, SF#4 and SF#7 in the first TDD configuration which are carried by UL processes #2, #3 and #4. All of them have failed during the transmission and have to be retransmitted. According to the defined DL feedback timing, the DL feedback of SF#3, SF#4 and SF#7 is in SF#0 and SF#1 in the TDD configuration respectively. The retransmission of UL process #2, #3 and #4 in the first TDD configuration will be entirely mapped to SF#7 in the second TDD configuration.

A pre-defined set of rules is used to select one UL process to perform the retransmission and drop all other retransmissions. For example, in selecting the UL process with the largest DL feedback timing for the retransmission, the user equipment UE will perform retransmission in SF#7 in the second TDD configuration for UL process#2 in the first TDD configuration. The eNB will combine the received packet in SF#7 in the second TDD configuration with the packet in UL process #2.

Embodiments of the present invention may be implemented in software, hardware, application logic or a combination of software, hardware and application logic. In an example embodiment, the application logic, software or instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

If desired, the different functions discussed herein may be performed in a different order and/or concurrently with each other.

Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

It is obvious to a person skilled in the art that with the advancement of technology, the basic idea of the invention may be implemented in various ways. The invention and its embodiments are thus not limited to the examples described above; instead they may vary within the scope of the claims.

1. A method, comprising:
receiving at least one failed packet in a first time division duplex (TDD) configuration;
receiving information to change from the first TDD configuration to a second TDD configuration;
sending a repeat request for said at least one failed packet; and
receiving a retransmission of the failed packets of the first TDD configuration in the second TDD configuration.

2. A method according to claim 1, comprising flushing a hybrid automatic repeat request (HARQ) buffer after receiving information to change from the first TDD configuration to the second TDD configuration and receiving the retransmission of the failed packets of the first TDD configuration in the second TDD configuration as new packets.

3. A method according to claim 2, comprising using a specified number of HARQ processors and downlink association set index in the second TDD configuration, wherein the downlink is configured for asynchronous HARQ.

4. A method according to claim 2, comprising using a specified number of HARQ processors and implicit timing between physical uplink shared channel (PUSCH) and physical HARQ indicator channel/physical downlink control channel (PHICH/PDCCH) in the second TDD configuration, wherein the uplink is configured for synchronous HARQ.

5. A method according to claim 1, comprising a network element indicating to an apparatus for wireless communication a downlink process index, setting a new data (NDI) value to indicate the retransmission and combining received packets with packets in a corresponding hybrid automatic repeat request (HARQ) process buffer used in the first TDD configuration, wherein the downlink is configured for asynchronous HARQ.

6. A method according to claim 1, comprising mapping a first uplink subframe in the second TDD configuration after a downlink feedback timing, adding a predetermined time period to the feedback timing and combining received packets with packets in a corresponding hybrid automatic repeat request (HARQ) process buffer used in the first TDD configuration, wherein the uplink is configured for synchronous HARQ.

7. A method according to claim 6, comprising retransmitting only normal subframes, if uplink HARQ processes in the first TDD configuration are mapped to the same uplink subframe.

8. A method according to claim 6, comprising retransmitting packets in one boundary subframe for corresponding packets in multiple boundary subframes in the first TDD configuration.

9. An apparatus for wireless communication, the apparatus comprising at least one processor and a memory storing computer instructions, wherein the processor and the memory with the computer instructions are configured to cause the apparatus, after receiving at least one failed packet in a first time division duplex (TDD) configuration and information to change from the first TDD configuration to a second TDD configuration, to at least:
send a repeat request for said at least one failed packet; and
receive a retransmission of the failed packets of the first TDD configuration in the second TDD configuration.

10. An apparatus according to claim 9, wherein the processor and the memory with the computer instructions are further configured to cause the apparatus to flush a hybrid automatic repeat request (HARQ) buffer after receiving information to change from the first TDD configuration to the second TDD configuration and to receive the retransmission of the failed packets of the first TDD configuration in the second TDD configuration as new packets.

11. An apparatus according to claim 10, wherein the processor and the memory with the computer instructions are further configured to cause the apparatus to use a specified number of HARQ processors and downlink association set index in the second TDD configuration, wherein the downlink is configured for asynchronous HARQ.

12. An apparatus according to claim 10, wherein the processor and the memory with the computer instructions are further configured to cause the apparatus to use a specified number of HARQ processors and implicit timing between physical uplink shared channel (PUSCH) and physical HARQ indicator channel/physical downlink control channel (PHICH/PDCCH) in the second TDD configuration, wherein the uplink is configured for synchronous HARQ.

13. An apparatus according to claim 9, wherein the processor and the memory with the computer instructions are further configured to cause the apparatus to:
detect packets to be retransmitted from the downlink process index comprising packets from the first TDD configuration and a new data indicator (NDI) value, and
combine received packets with packets in a corresponding hybrid automatic repeat request (HARQ) process buffer used in the first TDD configuration,
wherein the downlink is configured for asynchronous HARQ.

14. An apparatus according to claim 9, wherein the processor and the memory with the computer instructions are further configured to cause the apparatus to:
map a first uplink subframe in the second TDD configuration after a downlink feedback timing,
add a predetermined time period to the feedback timing; and
combine received packets with packets in a corresponding hybrid automatic repeat request (HARQ) process buffer used in the first TDD configuration, wherein the uplink is configured for synchronous HARQ.

15. An apparatus according to claim 14, wherein the processor and the memory with the computer instructions are further configured to cause the apparatus to retransmit only normal subframes, if uplink HARQ processes in the first TDD configuration are mapped to the same uplink subframe.

16. An apparatus according to claim 14, wherein the processor and the memory with the computer instructions are further configured to cause the apparatus to retransmit packets in one boundary subframe for corresponding packets in multiple boundary subframes in the first TDD configuration.

17. A network element for wireless communication, the apparatus comprising at least one processor and a memory storing computer instructions, wherein the processor and the memory with the computer instructions are configured to cause the apparatus, after receiving at least one failed packet in a first time division duplex (TDD) configuration and information to change from the first TDD configuration to a second TDD configuration, to at least:
send a repeat request for said at least one failed packet; and
receive a retransmission of the failed packets of the first TDD configuration in the second TDD configuration.

18. A network element according to claim 17, wherein the processor and the memory with the computer instructions arc further configured to cause the apparatus to flush a hybrid automatic repeat request (HARQ) buffer after receiving information to change from the first TDD configuration to the second TDD configuration and to receive the retransmission of the failed packets of the first TDD configuration in the second TDD configuration as new packets.

19. A network element according to claim 18, wherein the processor and the memory with the computer instructions are further configured to cause the apparatus to use a specified number of HARQ processors and downlink association set index in the TDD configuration from uplink to downlink, wherein the downlink is configured for asynchronous HARQ.

20. A network element according to claim 17, wherein the processor and the memory with the computer instructions are further configured to cause the apparatus to use a specified number of hybrid automatic repeat request (HARQ) processors and implicit timing between physical uplink shared channel (PUSCH) and physical HARQ indicator channel/physical downlink control channel (PHICH/PDCCH) in the second TDD configuration, wherein the uplink is configured for synchronous HARQ.

21-22. (canceled)
